(19) United States
(12) Patent Application Publication
(10) Pub. No.: US 2025/0050270 A1
(43) Pub. Date: Feb. 13, 2025

(54) WATER REMOVAL SYSTEM INCLUDING AN ABSORPTION CHILLER SYSTEM AND A HEAT PUMP SYSTEM

(71) Applicant: Scuderi Group, Inc., West Springfield, MA (US)

(72) Inventor: Salvatore C. SCUDERI, Westfield, MA (US)

(73) Assignee: Scuderi Group, Inc., West Springfield, MA (US)

(21) Appl. No.: 18/448,507

(22) Filed: Aug. 11, 2023

(51) Int. Cl. B01D 53/26; B01D 53/22; F25B 25/02

(52) U.S. Cl. CPC B01D 53/268; B01D 53/229; B01D 53/265; F25B 25/02; B01D 2053/221; B01D 2257/80; B01D 2258/01

(57) ABSTRACT

A water removal system includes an absorption chiller system and a heat pump system. The absorption chiller system includes a generator section, a condenser section, an evaporator section and an absorber section all in fluid communication and which operate to circulate water as a first refrigerant therethrough. The heat pump system includes a heat pump compressor, a heat pump condenser and a heat pump evaporator all in fluid communication and which operate to circulate a second refrigerant therethrough. The heat pump evaporator is in heat exchange communication with at least one of the condenser section or the absorber section and is configured to evaporate the second refrigerant to transfer heat from the first refrigerant to the second refrigerant. The heat pump condenser is in heat exchange communication with the generator section and is configured to condense the second refrigerant to transfer heat from the second refrigerant to first refrigerant.

### TECHNICAL FIELD

The present disclosure relates to water removal systems and methods of using the same. More specifically, the disclosure relates to water removal systems which include heat pump systems and absorption chiller systems, wherein the absorption chiller systems have evaporators that include a transport membrane heat exchanger.

### BACKGROUND

Cooling and drying a fluid which contains water (a hydrated fluid), without utilizing an undue amount of energy is a challenging problem in several industrial applications. Examples of such industrial applications would be cooling and drying air in an air conditioning system or cooling and drying exhaust gas from an internal combustion engine in a bottoming cycle power system.

In the case of exhaust gas from an internal combustion engine, one of the most challenging aspects of today's energy technologies is to effectively convert waste heat from the exhaust gas of a combustion process into useable power. Systems of converting waste heat into useful forms of energy are commonly referred to as bottoming cycle power systems, or other combustion systems such as gas or oil fired furnaces.

Bottoming cycle power systems often include an expansion turbine (or turbo-expander) connected to a compression turbine (or turbo-compressor) via a common crankshaft. The exhaust gas flows through the turbo-expander where it may exit the turbo-expander at below atmospheric pressures (or vacuum pressures). The vacuum pressures are caused by the turbo-compressor, which pumps the exhaust gas back to atmospheric pressures as the exhaust gas exits the bottoming cycle power system. The amount of usable energy (or net-work) recovered from a bottoming cycle power system is the energy produced by the turbo-expander minus the energy consumed by the turbo-compressor. Therefore, the less work needed by the turbo-compressor to compress the expanded volume of exhaust gas, the greater the net-work produced from the bottoming cycle power system.

Various prior art cooling systems may be utilized to reduce the specific volume of exhaust gas prior to entering the turbo-compressor and, therefore, reduce the amount of work required by the turbo-compressor to compress the exhaust gas. Problematically however, these cooling systems consume a significant amount of energy due to pumps and/or other energy consuming devices needed to circulate coolants through the cooling system.

Further, the exhaust gas of an internal combustion engine contains a significant amount of water vapor. The water vapor has a relatively high specific volume and mass, which causes an unwanted burden on the compression work of the turbo-compressor. Problematically, removing the water from a flow of exhaust gas using current techniques often requires a significant amount of energy.

Accordingly, there is a need for a system and method of cooling and drying a hydrated fluid without utilizing an undue amount of energy. There is a need for cooling and drying air in an air conditioning system with as little energy as possible. Further, there is also a need for cooling and drying exhaust gas from an internal combustion engine with as little energy as possible.

### BRIEF DESCRIPTION

The present disclosure offers advantages and alternatives over the prior art by providing a water removal system which includes an absorption chiller system and a heat pump system. The absorption chiller system circulates water acting as a first refrigerant through a generator section, a condenser section, an evaporator section and an absorber section. The heat pump system includes a heat pump evaporator, which is utilized to cool the absorber section and/or the condenser section of the absorption chiller system. The heat pump system also includes a heat pump condenser, which is utilized to heat the generator section of the absorption chiller system. Advantageously, the heat pump system utilizes heat energy from the absorber section and the condenser section to heat the first refrigerant in the generator section, which increases the efficiency of the water removal system, down-sizes the water removal system and reduces the waste heat produced by the water removal system.

A water removal system in accordance with one or more aspects of the present disclosure includes an absorption chiller system and a heat pump system. The water absorption system includes a generator section, a condenser section, an evaporator section and an absorber section all in fluid communication with each other and which operate to circulate water as a first refrigerant therethrough. The heat pump system includes a heat pump compressor, a heat pump condenser and a heat pump evaporator all in fluid communication with each other and which operate to circulate a second refrigerant therethrough. The heat pump evaporator is in heat exchange communication with at least one of the condenser section or the absorber section. The heat pump evaporator is configured to evaporate the second refrigerant to transfer heat from the first refrigerant to the second refrigerant. The heat pump condenser is in heat exchange communication with the generator section. The heat pump condenser is configured to condense the second refrigerant to transfer heat from the second refrigerant to first refrigerant.

In some examples of the present disclosure the second refrigerant comprises one of water, carbon dioxide or refrigerant R471.

In some examples of the present disclosure the heat pump evaporator is configured to evaporate the second refrigerant within a temperature range of 60 degrees Fahrenheit to 100 degrees Fahrenheit.

In some examples of the present disclosure the heat pump condenser is configured to condense the second refrigerant within a temperature range of 180 degrees Fahrenheit to 200 degrees Fahrenheit.

In some examples of the present disclosure the evaporator section includes a transport membrane heat exchanger having a first flow path and a second flow path. The first flow path is operable to flow the first refrigerant therethrough under a vacuum pressure that is low enough to vaporize the first refrigerant within the first flow path. The second flow path is operable to flow a fluid having water therethrough. Both water and heat are transferred from the fluid in the second flow path to the first refrigerant in the first flow path through a membrane-based material of the transport membrane heat exchanger, such that the fluid passing through the second flow path has at least a portion of its water removed and is cooled.

In some examples of the present disclosure the membrane-based material of the transport membrane heat exchanger includes a plurality of membrane tubes. Each tube of the plurality of tubes includes an outside diameter, an inside diameter and a porous tube wall therebetween. The inside diameter of each tube defines a tube passageway therethrough. The first flow path extends through the tube passageway of each tube. The second flow path extends around the outside diameter of each tube. Both water and heat from the fluid passing through the second flow path migrates through the tube walls of each tube to the first refrigerant in the first flow path.

In some examples of the present disclosure, the fluid in the second flow path includes a flow of exhaust gas from an internal combustion engine.

In some examples of the present disclosure, the second flow path is operable to flow the exhaust gas therethrough under a vacuum pressure, the vacuum pressure in the second flow path being greater than the vacuum pressure in the first flow path.

A method of removing water from a fluid in accordance with one or more aspects of the present disclosure includes flowing water acting as a first refrigerant under a vacuum pressure through a first flow path of a transport membrane heat exchanger of an evaporator section of an absorption chiller system. The water acting as the first refrigerant is vaporized within the first flow path. A fluid containing water is flowed through a second flow path of the transport membrane heat exchanger. Heat and water are transferred from the fluid in the second flow path to the water acting as a first refrigerant in the first flow path through a membrane-based material of the transport membrane heat exchanger. The water from the fluid mixes with the water acting as a first refrigerant to provide a first flow of steam. The fluid passing through the second flow path has at least a portion of its water removed and is cooled. The first flow of steam is transferred into an absorber section of the absorption chiller system. The absorber section is in heat exchange communication with a heat pump evaporator of a heat pump system. The first flow of steam is condensed into a first refrigerant solution of water and salt by transferring heat from the first flow of steam to a second refrigerant vaporized in the heat pump evaporator. The first refrigerant solution is pumped into a second refrigerant solution of water and salt in a generator section of the absorption chiller system. The generator section is in heat exchange communication with a heat pump condenser of the heat pump system. The water acting as a first refrigerant and the water from the fluid is evaporated out of the second refrigerant solution to provide a second flow of steam by transferring heat from the second refrigerant condensed in the heat pump condenser to the second refrigerant solution.

In some embodiments of the method, the second flow of steam is transferred into a condenser section of the absorption chiller system. The condenser section is in heat exchange communication with the heat pump evaporator of the heat pump system. The second flow of steam is condensed by transferring heat from the second flow of steam to the second refrigerant vaporized in the heat pump evaporator.

In some embodiments of the method, the condensed water from the fluid in the condenser section is pumped up to atmospheric pressure to remove the water from the fluid out of the absorption chiller system.

In some embodiments of the method, the condensed water acting as a first refrigerant in the condenser section if flowed through an orifice and back into the first flow path of the transport memory heat exchanger of the evaporator section of the absorption chiller system.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a water removal system having an absorption chiller system and a heat pump system, according to aspects described herein;

FIG. 2 depicts an example of a cross sectional view of an evaporator section of the absorption chiller system of the water removal system of FIG. 1, wherein the evaporator section includes a transport membrane heat exchanger, according to aspects described herein;

FIG. 3 depicts an example of a cross sectional view of a membrane tube of the transport membrane heat exchanger, according to aspects described herein;

FIG. 4 depicts an example of an enlarged view of the circular area 4-4 of FIG. 3, according to aspects described herein;

FIG. 5 depicts an example of a schematic view of the water removal system of FIG. 1, wherein the fluid to be cooled and dried includes a flow of exhaust gas from an internal combustion engine, according to aspects described herein;

FIG. 6 depicts an example of a flow diagram of a method of removing water from a fluid, according to aspects described herein; and

FIG. 7 depicts an example of a flow diagram of a continuation of the method of FIG. 7, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

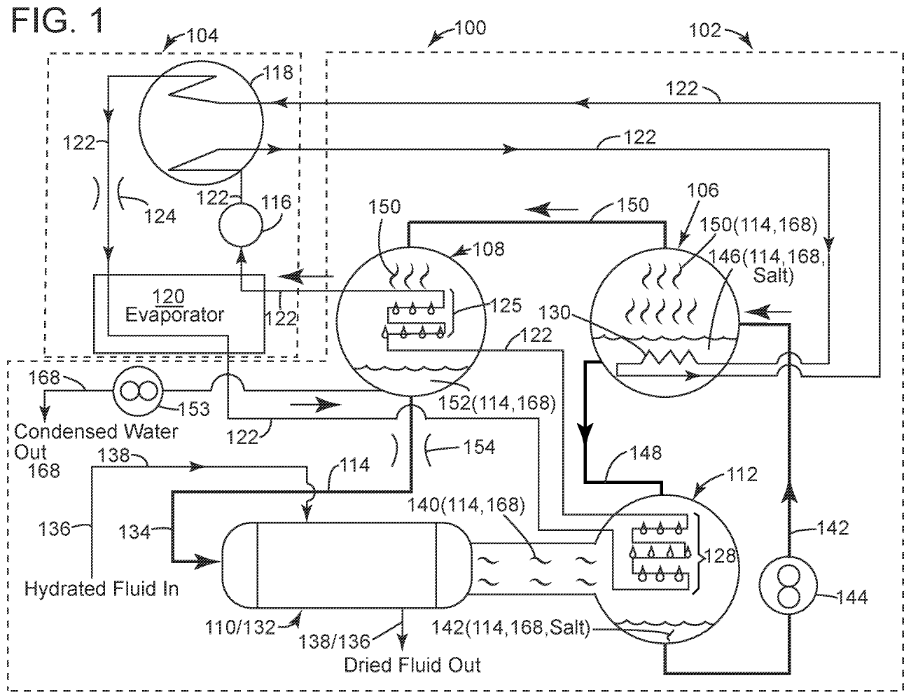

Referring to FIG. 1, an example is depicted of a water removal system 100, having an absorption chiller system 102 and a heat pump system 104, according to aspects described herein. The absorption chiller system 102 includes a generator section 106, a condenser section 108, an evaporator section 110 and an absorber section 112 all in fluid communication with each other and which operate to circulate water 114 as a first refrigerant (herein also referred to as “water/first refrigerant” 114) therethrough.

The heat pump system 104 includes a heat pump compressor 116, a heat pump condenser 118 and a heat pump evaporator 120 all in fluid communication with each other and which operate to circulate a second refrigerant 122 therethrough. The second refrigerant may be, for example, water, carbon dioxide, refrigerant R-471A or the like. A commercial example of refrigerant R-471A is sold under the brand name: Solstice® N71, which is manufactured by Honeywell International, Inc, having a corporate headquarters in Charlotte, North Carolina, USA.

During operation of the heat pump system 104, the second refrigerant 122 enters the heat pump compressor 116 as a low pressure and low temperature vapor or gas. Then the pressure and temperature of the second refrigerant 122 is increased, as the heat pump compressor 116 does compression work on the second refrigerant 122. The second refrigerant 122 then leaves the heat pump compressor 116 as a higher temperature and higher pressure (often superheated) gas. The second refrigerant 122 then passes through the heat pump condenser 118 where it releases heat to the surroundings as it cools and condenses (for example, at about 180 degrees Fahrenheit (F) to 200 degrees Fahrenheit (F)). The cooler high-pressure liquid second refrigerant 122 next passes through a heat pump orifice 124 (such as, for example, a simple restriction or an expansion valve or a throttle valve or the like) which reduces the pressure abruptly causing the temperature to drop substantially. The cold low pressure mixture of liquid and vapor second refrigerant 122 next travels through the heat pump evaporator 120 where the second refrigerant 122 vaporizes (for example, at about 60 degrees F. to 100 degrees F.) as it accepts heat from the surroundings before returning to the heat pump compressor 116 as a low pressure low temperature gas to start the cycle again.

The heat pump evaporator 120 is in heat exchange communication with at least one of the condenser section 108 or the absorber section 112 of the absorption chiller system 102. In this example, the heat pump evaporator 120 is in heat exchange communication with both the condenser section 108 and the absorber section 112. The heat pump evaporator 120 is configured to evaporate the second refrigerant 122 to transfer (or absorb) heat from the water acting as a first refrigerant 114 to the second refrigerant 122. The heat pump evaporator 120 may be configured to evaporate the second refrigerant 122 within a temperature range of about 60 degrees Fahrenheit to 100 degrees Fahrenheit.

In other words, as the second refrigerant 122 evaporates in heat pump evaporator 120, the second refrigerant cools the water acting as a first refrigerant 114 in either or both the condenser section 108 and absorber section 112 of the absorption chiller system 102. In the example illustrated in FIG. 1, condenser cooling coils 126 of the condenser section 108 and absorber cooling coils 128 of the absorber section 112 are an integral part of the heat pump evaporator 120, wherein the second refrigerant 122 circulates through the condenser cooling coils 126 and absorber cooling coils 128 and evaporates therein.

However, several other configurations are also within the scope of this disclosure that enable the heat pump evaporator 120 to be in heat exchange communication with the condenser section 108 and/or absorber section 112. For example, the second refrigerant 122 may be in heat exchange communication with the water/first refrigerant 114 through a separate and intermediate first 114 to second refrigerant 122 heat exchanger (not shown), wherein the second refrigerant 122 evaporates, and the water/first refrigerant 114 is cooled, within the separate first to second refrigerant heat exchanger. Also, by way of example, the water acting as the first refrigerant 114 may be circulated from either the condenser section 108 or absorber section 112 into the main body of the heat pump evaporator 120 to be cooled therein.

The heat pump condenser 118 is in heat exchange communication with the generator section 106 of the absorption chiller system 102. The heat pump condenser 118 is configured to condense the second refrigerant 122 to transfer heat from the second refrigerant 122 to the water acting as the first refrigerant 114. The heat pump condenser 118 may be configured to condense the second refrigerant 122 within a temperature range of about 180 degrees Fahrenheit to 200 degrees Fahrenheit.

In other words, as the second refrigerant 122 condenses in heat pump condenser 118, the second refrigerant heats the water acting as a first refrigerant 114 in the generator section 106 of the absorption chiller system 102. In the example illustrated in FIG. 1, heating cooling coils 130 within the generator section 106 are an integral part of the heat pump condenser 118, wherein the second refrigerant 122 circulates through the heating coils 130 and condenses therein to heat the water/first refrigerant 114.

However, several other configurations are also within the scope of this disclosure that enable the heat pump condenser 118 to be in heat exchange communication with the generator section 106. For example, the second refrigerant 122 may be in heat exchange communication with the water/first refrigerant 114 through a separate and intermediate first 114 to second refrigerant 122 heat exchanger (not shown), wherein the second refrigerant 122 condenses, and the water/first refrigerant 114 is heated, within the separate first to second refrigerant heat exchanger. Also, by way of example, the water acting as the first refrigerant 114 may be circulated from the generator section 106 into the main body of the heat pump condenser 118 to be heated therein.

Advantageously, by using heat pump system 104 to cool the water/first refrigerant 114 in the condenser section 108 and/or absorber section 112, the condenser section 108 and absorber section 112 are more efficiently cooled than, for example, using a water tower (not shown) to cool them. Also advantageously, by using the heat pump system to heat the water 114 in the generator section 106, less waste heat is generated and, therefore, the water/first refrigerant 114 in the generator section 106 is also more efficiently heated.

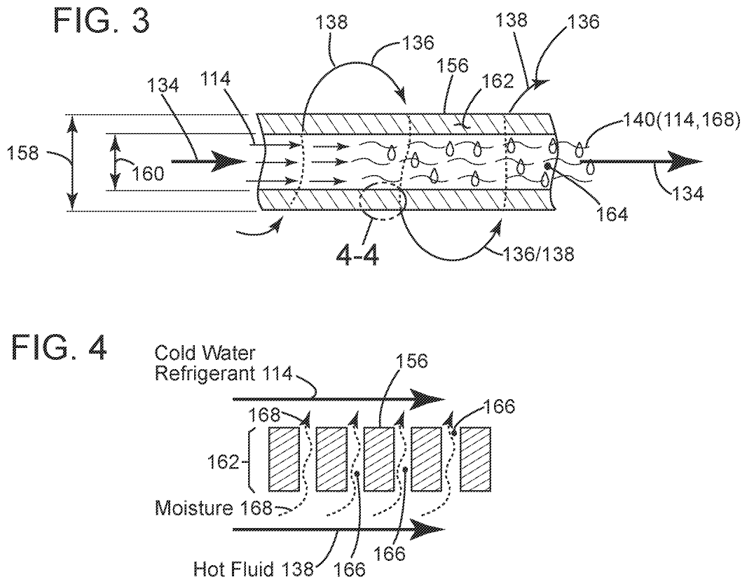

However, as will be explained in more detail herein, because additional water 168 from a separate fluid 138 (see FIGS. 3 and 4) is being added to the water acting as a first refrigerant 114 in the evaporator section 110 of the absorption chiller system 102, there may be a significantly more heat generated at the heat pump condenser 118 than is required to evaporate the water/first refrigerant 114 in the generator section 106. Accordingly, an extra heat exchanger (not shown) (such as a second refrigerant 122 to air heat exchanger) may be required to be connected between the heat pump condenser 118 and the generator section 106 to remove the excess heat and balance the energy flow of the water removal system 100.

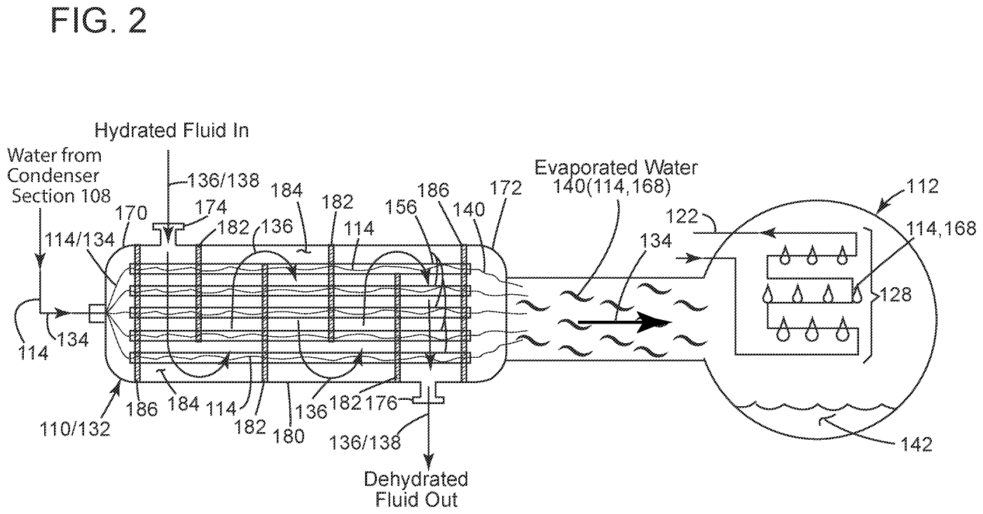

The evaporator section 110 of the absorber chiller system 102 may include a transport membrane heat exchanger 132. In some embodiments the evaporator section 110 may include more than the transport membrane heat exchanger 132. However, in the examples shown herein, the evaporator section 110 includes only the transport membrane heat exchanger 132 and, therefore, may be referred to interchangeably throughout or may be referred to herein as the evaporator section/transport membrane heat exchanger 110/132. The transport membrane heat exchanger 132 includes membrane-based material (such as, for example, membrane tubes (see FIG. 2)) through which both heat energy and mass (such as water) can flow.

Membrane-based materials and membrane-based devices (such as vapor permeation membranes, membrane condensers and transport membrane heat exchangers (sometimes known as transport membrane condensers)) can transport heat energy and selectively water molecules, so that they may be used as a tool to control the flow of heat and water across the membrane-based material. Accordingly, membrane-based materials can be utilized to cool and dry certain fluids, such as air or exhaust gas from an internal combustion engine.

The membrane-based material may, for example, be a porous fine ceramic material, which may be sintered from Alumina, Titania or Zirconia. The membrane-based material may be composed of a hydrophobic polymer membrane, which may have pore sizes within a variety of ranges. For example, the pore sizes may be within a range of about: 0.1 to 0.2 micrometers, 0.2 micrometers or less, 0.1 micrometers or less, 0.5 micrometers or less, 0.2 micrometers or less, 0.1 micrometers or less, or 0.01 to 0.02 micrometers.

The membrane-based material may employ hydrophilic ceramic membranes with a high thermal conductivity to condense water vapors within the membrane pores. The membrane-based material may also include polymeric membrane material, such as a block copolymer or a sulfonated poly (ether ether ketone) (i.e., SPEEK).

The transport membrane heat exchanger 132 includes a first flow path 134 and a second flow path 136 (see FIG. 2). The first flow path 134 is operable to flow the water/first refrigerant 114 therethrough under a vacuum pressure that is low enough to vaporize the water acting as a first refrigerant 114 within the first flow path 134. As will be explained in greater detail herein, it is advantageous that at least the first flow path 134 of the transport membrane heat exchanger 132 be operable to flow the water/first refrigerant 114 under vacuum pressures that induces evaporation of the water/first refrigerant 114. One of the reasons this is advantageous is because this helps to maintain a large pressure differential across the membrane-based materials, which enhances the migration of water across the membrane. Another reason this is advantageous is because, as water 168 (see FIG. 4) contained in a fluid 138 in the second flow path 136 migrates across the membrane-based materials, the water 168 almost simultaneously condenses out of the fluid in the second flow path 136 as the water 168 passes through the porous walls of the membrane-based materials and evaporates into a gas as the water 168 mixes with the evaporated water acting as a first refrigerant 114 in the first flow path 134. Accordingly, the latent heat of vaporization of water is almost balanced out (or nullified) by the change of state of the water 168 from gas (in the second flow path 136) to liquid (in the pours of the membrane-based material) and back to a gas again (in the first flow path 134). Accordingly, because the latent heat of vaporization of the water 168 from the fluid 138 in the second flow path 136 does not have to be absorbed by the evaporated water acting as the first refrigerant 114 in the evaporator section 110, there is much less flow required for the water/first refrigerant 114 to absorb the same amount of water 168 migrating across the membrane-based material than if the water acting as the first refrigerant 114 were not evaporating. For example, there may be as much as one half to one tenth the amount of volume of water flow of the water/first refrigerant 114 required to migrate the water 168 from the fluid 138 in the second path 136 when the water/first refrigerant 114 is evaporated than when it is not evaporated. This substantially downsizes the evaporator 110/transport membrane heat exchanger 132 and helps to increase the overall efficiency of the entire water removal system 100.

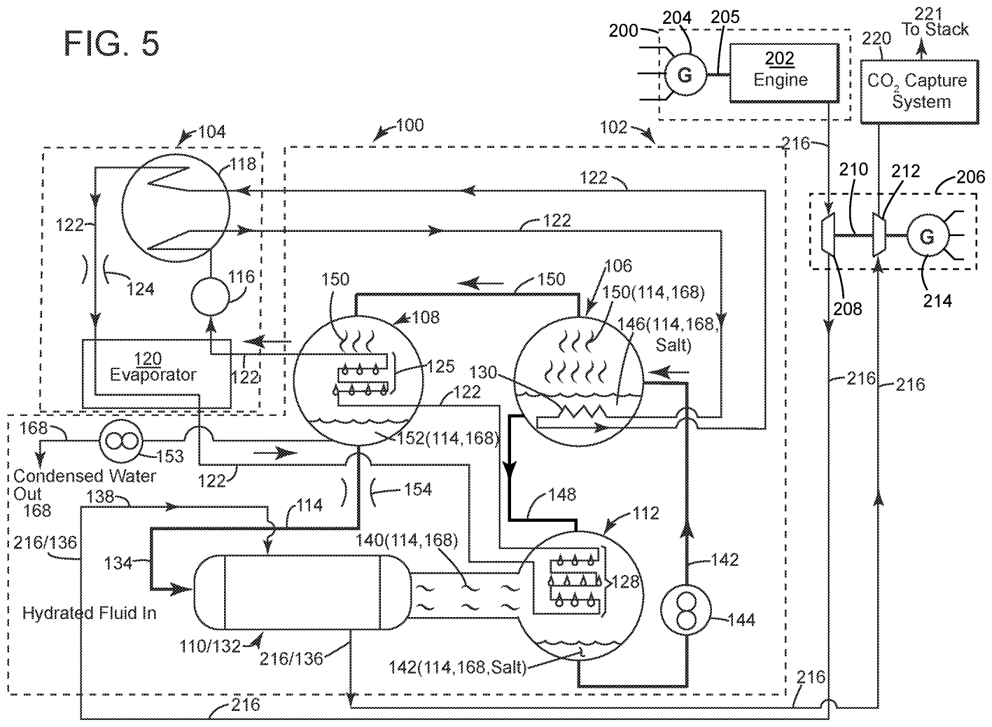

The second flow path 136 of the evaporator section 110/transport membrane heat exchanger 132 is operable to pass a fluid 138 having water 168 (see FIG. 4) therethrough. For example, the fluid 138 may be air or may be exhaust gas 216 from an internal combustion engine 202 (see FIG. 5).

Within the evaporator section 110/transport membrane heat exchanger 132, both water 168 and heat are transferred from the fluid 138 in the second flow path 136 to the water/first refrigerant 114 in the first flow path 134 through the membrane-based material (such as membrane tubes 156 (see FIG. 2)) of the transport membrane heat exchanger 132. Accordingly, the fluid 138 passing through the second flow path 136 has at least a portion of its water 168 removed and the fluid 138 is cooled.

The flow of fluid 138 in the second flow path 136 may be air or may be a flow of exhaust gas 216 from an internal combustion engine 202 (see FIG. 5). If the flow of fluid 138 is exhaust gas 216, then the second flow path 136 may be operable to flow the exhaust gas 216 therethrough under a vacuum pressure. However, advantageously, the vacuum pressure in the second flow path 136 may be at a greater pressure than the vacuum pressure in the first flow path 134. As such, the pressure differential is advantageously from the higher absolute pressure in the second flow path 136 (through which the hydrated fluid 138 flows) to the lower absolute pressure in the first flow path 134 (through which the water acting as a first refrigerant 114 flows). This pressure differential across the membrane-based material (such as membrane tubes 156 (see FIG. 2)) of the transport membrane heat exchanger 132 enhances the migration of water 168 in the fluid 138 to the water/first refrigerant 114. The water 168 transferred from the fluid 138 in the second flow path 136 mixes with the water functioning as a first refrigerant 114 in the first flow path 134 to form a combined flow of water 114, 168 (i.e., the flow of water/first refrigerant 114 plus the flow of water 168 from the fluid 138). As will be explained in greater detail herein, the combined flow of water 114, 168 in the first flow path 134 flows as a first flow of steam 140 from the evaporator section 110 to the absorber section 112.

From the evaporator section 110, the combined flow of water 114, 168 (i.e., the water/first refrigerant 114 and the additional absorbed water 168) flow primarily as a first flow of steam 140 to the absorber section 112. The absorption section 112 contains a first refrigerant solution 142, which often may be considered a brine solution. The first refrigerant solution 142 is composed of the combined flow of water 114, 168 from the evaporator section 110 plus may also include a salt (such as lithium bromide) or ammonia. However, other refrigerant solutions that meet the thermodynamic requirements of the absorption chiller system 102 may also be used. In this specific embodiment, the first refrigerant solution 142 is a brine solution of lithium bromide and the combined flow of water 114, 168. The first solution 142 is operable to re-condense the first flow of steam 140 utilizing the cooling coils 128 which are in heat exchange communication with the heat pump evaporator 120 of the heat pump system 104.

Advantageously, the latent heat of vaporization of the water 168 from the fluid 138 is removed from the combined flow of water 114, 168 by the cooling coils 128 of the heat pump evaporator 120 in the absorber section 112 as the water 168 from the fluid 138 is condensed to a liquid. This would not have been the case if the water/first refrigerant 114 did not advantageously evaporate in the transport membrane heat exchanger 132 and, instead remained a liquid. As explained earlier herein, because the water/first refrigerant 114 evaporated in the transport membrane heat exchanger 132/evaporator section 110, the latent heat of vaporization of the water 168 from the fluid 138 was balanced out by the almost instantaneous change of state of the water 168 from gas to liquid and back to gas again as the water 168 migrated across the pours in the membrane based material of the transport membrane heat exchanger 132. Essentially, this delayed the requirement of removing from the water removal system 100 the latent heat of vaporization of the water 168 from the fluid 138 till the combined flow of water 114, 168 reached the absorber section 112 as the first flow of steam 140.

Because the cooling coils 128, which are positioned in the absorber section 112, function as a part of the evaporator 120 of the heat pump system 104, the cooling coils are capable of removing heat from the first flow of steam 140 (i.e., the vaporized combined flow of water 114, 168) much more efficiently than the evaporator section 110 of the absorption chiller system 102. This is because the coefficient of performance (COP) of the heat pump system 104 is several times higher than that of an absorption chiller system 102.

The coefficient of performance or COP of a heat pump system (such as heat pump system 104) is the ratio of useful heating or cooling provided to work (energy) required. Higher COPs equate to higher efficiency, lower energy (power) consumption and thus lower operating costs and smaller sizes to remove the same amount of heat energy.

The COP of a heat pump system usually exceeds 1, because, instead of just converting work to heat (which, if 100% efficient, would be a COP of 1), the heat pump moves heat from a heat source to where the heat is required. Because less work is required to move heat than to convert heat, heat pumps may have a COP of 2.3 to 3.5.

In direct contrast, the COP of an absorption chiller system is typically lower than 1. This is because absorption chiller systems (such as absorption chiller system 102) do not rely on compression (such as in a heat pump system) to convert or move heat, but instead rely on chemical reactions driven by heat to convert or move heat.

Accordingly, in the water removal system 100 of the present disclosure, removing the latent heat of vaporization of the water 168 from the fluid 138 is not performed in the evaporator section 110. Rather it is delayed until the water 168 from the fluid 138 reaches the absorber section 112, where removal of the latent heat of vaporization of the water 168 from the water removal system 100 can be done much more efficiently.

The lithium bromide (or salt) in the first refrigerant solution 142 has a strong chemical attraction for the first flow of steam 140 from the evaporator section 110 as the combined flow of water 114, 168 and salt naturally tend to combine in the absorber section 112. The attraction is so great, that it helps to maintain the near total vacuum pressures of, for example, about 1.0 pounds per square inch absolute (psia) or less, about 0.2 psia or less, or about 0.12 psia or less in the evaporator and absorber sections 110, 112.

Advantageously, the strong chemical attraction of the salt for the water 114, 168 in the absorber section 112 enables the near total vacuum pressures in the evaporator section 110, and therefore in the first flow path 134 of the transport membrane heat exchanger 132, without the use of any external vacuum pumps. This is advantageous because vacuum pumps consume a lot of electrical energy when running.

A solution pump 144 is in fluid communication with the first refrigerant solution 142 in the absorber section 112 and a second refrigerant solution 146 in the generator section 106. The second refrigerant solution 146 has the same molecular composition as the first refrigerant solution 142, but has a different percentage of water 114, 168. The solution pump 144 is operable to pump the first refrigerant solution 142 in the absorber section 112 to the second refrigerant solution 146 in the generator section 106.

Additionally in this embodiment, the second refrigerant solution 146 is gravity fed through tubing 148 back down to the absorber section 112 where the second refrigerant solution 146 may be sprayed on the cooling coils 128 that are disposed within the absorber section 112. The absorber cooling coils 128 are also cooled, in this embodiment, by the second refrigerant 122 circulating through the cooling coils 128 from the heat pump evaporator 120 of heat pump 104.

The generator section 106 utilizes the high temperature second refrigerant 122 from the heat pump condenser 118 as a heat source for the heating coils 130 within the generator section 106. The high temperature refrigerant 122 from the heat pump condenser 118 is operable to transfer heat into the generator section 106. The heat transferred into the generator section 106 boils the second refrigerant solution 146 of the water acting as a first refrigerant 114 and the water 168 from the fluid 138 to produce a second flow of steam 150 in the generator section 106. The second flow of steam 150 is essentially the second time vaporized combined flow of water 114, 168. The second refrigerant solution 146 is generally a solution of salt and water or a solution of ammonia and water, although other refrigerant solutions that meet the thermodynamic requirements of the absorption chiller system 102 can also be used. In this specific embodiment, the second refrigerant solution 146 is a brine solution of lithium bromide and water.

Because the second refrigerant 122 may contain the heat energy absorbed from the combined flow of water 114, 168 that flows through both the absorber section 112 and condenser section 108, there may be a significantly more heat generated at the heat pump condenser 118 than is required to evaporate the combined flow of water 114, 168 in the generator section 106. Accordingly, an extra heat exchanger (not shown) (such as a second refrigerant 122 to air heat exchanger) may be required to be connected between the heat pump condenser 118 and the generator section 106 to remove the excess heat and balance the energy flow of the water removal system 100.

Once the second flow of steam 150 has evaporated out of the second refrigerant solution 146, it flows into the condenser section 108 of the absorption chiller system 102. The condenser section 108 and generator section 106 are almost always located above the evaporator section 110 and absorber section 112 of the absorption chiller system 102. The condenser section 108 and generator section 106 are also maintained at approximately the same pressure, which is a higher pressure than the evaporator section 110 and absorber section 112. For example, the generator and condenser sections 106, 108 are often maintained within a range of about atmospheric pressure (i.e., 14.7 pounds per square inch absolute (psia)) to a vacuum pressure of about 4.9 psia. Whereas the evaporator and absorber sections 110, 112 are often maintained at a pressure of about 0.12 psia or lower.

Advantageously, the pressure within the first flow path 134 of the transport membrane heat exchanger 132 will also be at, or about, the same very low vacuum pressures of the evaporator section 110. For example, the pressures within the first flow path 134 may be at a pressure of about 5 psia or less, 4 psia or less, 3 psia or less, 2 psia or less, 1 psia or less, 0.2 psia or less, 0.12 psia or less or 0.1 psia or less.

Also advantageously, the pressures within the first flow path 134 may be under a vacuum pressure that is low enough to vaporize the water acting as a first refrigerant 114 within the first flow path 134, which greatly enhances the transfer of heat energy from the fluid 138 to the refrigerant 114 without raising the temperature of the refrigerant 114. For example, at a vacuum pressure of 0.12 psia or less in the first flow path 134, the water acting as the first refrigerant 114 would evaporate at about 40 degrees Fahrenheit (F). This would provide an extremely effective cooling effect, since the latent heat of vaporization of water is larger than almost any other commercially available refrigerant, i.e., about 40.65 kilojoules per mole, or about 2230 joules per gram or about 533 calories per gram of water. Accordingly, a great deal of heat energy from the fluid 138 (e.g., air or exhaust gas) would be absorbed by the vaporizing water/first refrigerant 114 without raising the temperature of the water.

The condenser section 108 is operable to remove heat from the second flow of steam 150 and condense the steam into a flow of liquid water 152 (essentially a liquified combined flow of water 114, 168). More specifically in this embodiment, the condenser section 108 includes a set of condenser cooling coils 126 that are in fluid communication with the second refrigerant 122 from the heat pump evaporator 120. The cold condenser cooling coils 126 condense the second flow of steam 150 into the liquid water 152, which collects at the bottom of the condenser section 108.

Because the condensed liquid water 152 includes the water acting as a refrigerant 114 plus the water 168 removed from the fluid 138 as it passed through the second flow path 136 of the evaporator section 110, all or a portion of the excess water 168 may be pumped out of the condenser section 108 via water pump 153. The pump 153 may be required to remove the excess water 168 because the condenser section 108 operates under a vacuum and the pump 153 may be required to pump the water 168 from the vacuum pressure back up to atmospheric pressures of about 14.7 psia. The distilled water 168 removed from the water removal system 100 may be used as distilled water to produce various commercial products, such as drinking water product, or diesel exhaust fluid.

The remaining liquid water (essentially the water/first refrigerant 114) then flows from the condenser section 108 through an orifice 154 (such as, for example, a simple restriction or an expansion valve or a throttling valve or the like) and into the first flow path 134 of the transport membrane heat exchanger 132 of the evaporator section 110 as the water/first refrigerant 114. The orifice 154 provides and maintains a pressure differential between a first pressure of the condenser section 108 and a second lower pressure of the evaporator section 110. More specifically for this embodiment, the condenser section 108 may be at a vacuum pressure of about 4.9 psia where water boils at about 158 degrees F. and the evaporator section 110 may be at a much deeper vacuum pressure of about 0.12 psia where water boils at about 40 degrees F.

The pressure difference between the condenser section 108 and evaporator section 110 flash cools the liquid water/first refrigerant 114 as it enters the first flow path 134 of the transport membrane heat exchanger 132. The water functioning as the first refrigerant 114 then removes heat from the higher temperature fluid 138, which is passing through the second path 136 of the transport membrane heat exchanger 132.

Accordingly, the flow of liquid water/first refrigerant 114 from the condenser section 108 is re-evaporated in the first flow path 134 of the lower pressure transport membrane heat exchanger 132 of the evaporator section 110, to complete the cycle of the absorption chiller system 102.

Referring to FIGS. 2 and 3, an example is depicted of a cross sectional view of the transport membrane heat exchanger/evaporator section 110/132 (FIG. 2) and a cross sectional view of a membrane tube 156 (FIG. 3) of the transport membrane heat exchanger 132, according to aspects described herein. The membrane-based material of the transport membrane heat exchanger 132 includes a plurality of membrane tubes 156, each tube 156 of the plurality of tubes 156 includes an outside diameter 158, an inside diameter 160 and a porous ceramic tube wall 162 therebetween. The inside diameter 160 of each ceramic tube 156 defines a tube passageway 164 therethrough. The first flow path 134 (through which the water acting as a first refrigerant 114 flows) extends through a refrigerant entrance manifold 170 of the transport membrane heat exchanger 132 and into the tube passageway 164 of each tube 156. The first flow path 134 then extends from the tube passageway 164 of each tube 156 of the plurality of tubes 156 through a refrigerant exit manifold 172 of the transport membrane heat exchanger 132 to exit the evaporator section 110 and flow into the absorber section 112.

The second flow path 136 (through which the hydrated fluid 138 flows) extends through a fluid input port 174 of a heat exchanger outer shell 180 of the transport membrane heat exchanger 132. The heat exchanger outer shell 180 provides a hollow interior 184, which encloses the plurality of ceramic tubes 156. The heat exchanger outer shell is operable to withstand total vacuum pressures (e.g., up to 14.7 psia and more) without being damaged.

Once the hydrated fluid 138 flows through the fluid input port 174, it follows the second flow path 136, which extends around the outside diameter 158 of each membrane tube 156. Additionally, the second flow path 136 is directed laterally back and forth by a series of baffles 182 in a sinuous path as the second flow path 136 travels longitudinally along the hollow interior 184 toward an output port 176 of the transport membrane heat exchanger 132. The hollow interior 184 of the transport membrane heat exchanger 132 is sealed off from the refrigerant entrance manifold 170 and refrigerant exit manifold 172 by a pair of interior end walls 186, which are positioned on opposing longitudinal ends of the heat exchanger outer shell 180. The distal ends of each membrane tube 156 extend through each interior end wall 186 to enable the water/first refrigerant 114 to enter and exit the tube passageways 164 without mixing with the fluid 138 flowing through the second flow path 136 in the hollow interior 184 of the shell 180 of the transport membrane heat exchanger 132.

The second flow path 136 then extends through the output port 176 of the transport membrane heat exchanger 132 to exit the evaporator section 110. The fluid 138 which exits the output port 176 is now significantly cooled and dried of moisture. This is because, both water 168 and heat from the fluid 138 passing through the second flow path 136 migrate through the tube walls 162 of each tube 156 to the water acting as a first refrigerant 114 in the first flow path 134.

The first flow path 134 extends through the tube passageway 164 of each membrane tube 156. Therefore, the membrane tubes 156 are operable to flow the water acting as a first refrigerant 114 therethrough under a vacuum pressure that is low enough to vaporize the first refrigerant 114 within the tube passageways 164. For example, the pressures within the tube passageways 164 may be at a pressure of about 5 psia or less, 4 psia or less, 3 psia or less, 2 psia or less, 1 psia or less, 0.2 psia or less, 0.12 psia or less or 0.1 psia or less.

Accordingly, the water/first refrigerant 114 in each of the tube passageways 164 will be vaporized due to the low vacuum pressures. It is advantageous to vaporize the water/first refrigerant 114 within the tube passageways 164 because this helps to maintain a large pressure differential across the membrane-based tube walls 162, which enhances the migration of water 168 (see FIG. 4) across the membrane walls 162. Additionally, it is advantageous to vaporize the water/first refrigerant 114 within the tube passageways 164 because the heat energy of the fluid 138 in the second flow path 136 is readily absorbed by the water/first refrigerant 114 to overcome the latent heat of vaporization of the evaporating first refrigerant 114, which greatly enhances the heat transfer from fluid 138 to water/first refrigerant 114. Another reason this is advantageous is because, as water 168 (see FIG. 4) contained in the fluid 138 in the second flow path 136 migrates across the membrane-based materials, the water 168 almost simultaneously condenses out of the fluid in the second flow path 136 as the water 168 passes through the porous walls of the membrane-based materials and evaporates into a gas as the water 168 mixes with the evaporated water acting as a first refrigerant 114 in the first flow path 134. Accordingly, the latent heat of vaporization of water is almost balanced out (or nullified) by the change of state of the water 168 from gas (in the second flow path 136) to liquid (in the pours of the membrane-based material) and back to a gas again (in the first flow path 134). Accordingly, because the latent heat of vaporization of water does not have to be absorbed by the evaporated water acting as the first refrigerant 114 in the evaporator section 110, there is much less flow required for the first refrigerant 114 to absorb the same amount of water 168 migrating across the membrane-based material than if the water acting as the first refrigerant 114 were not evaporating. This substantially downsizes the evaporator section 110/transport membrane heat exchanger 132 and helps to increase the overall efficiency of the entire water removal system 100.

For example, at a vacuum pressure of 0.12 psia or less in the tube passageways 164, the water acting as a first refrigerant 114 would evaporate at about 40 degrees Fahrenheit (F). This would provide an extremely effective cooling effect, since the latent heat of vaporization of water is larger than almost any other commercially available refrigerant, i.e., about 40.65 kilojoules per mole, or about 2230 joules per gram or about 533 calories per gram of water. Accordingly, a great deal of heat energy from the fluid 138 (e.g., air or exhaust gas) would be absorbed by the vaporizing water/first refrigerant 114 without raising the temperature of the water 114. Additionally, a positive pressure differential from fluid 138 in the second flow path 136 to the water 114 in the first flow path 134 would be maintained in about a range of 10 to 15 pounds per square inch (psi), which would greatly enhance the migration of water 168 across the tube walls 162.

Also advantageously, the salt (such as lithium bromide) in the second solution 142 of the absorber section 112 would provide a strong chemical attraction for the first flow of steam 140 (see FIG. 1) as the combined flow of water 114, 168 and salt naturally tend to combine in the absorber section 112. The attraction is so great, that it would enable the maintenance of the near total vacuum pressures (for example, about 0.12 psia or less) in the evaporator section 110 and the absorber sections 112 without the use of a vacuum pump. This is advantageous because vacuum pumps consume a lot of electrical energy when running and further because a vacuum pump would expel the water acting as a first refrigerant 114 to the atmosphere.

Referring to FIG. 4, an example is depicted of an enlarged view of the circular area 4-4 of FIG. 3, according to aspects described herein. The enlarged view is a cross sectional view of the tube wall 162 of the membrane tubes 156.

The tube wall 162 is composed of a membrane-based material having a large number of pores 166 extending therethrough. In this case, the tube walls 162 are composed of a membrane based material. The membrane-based material may, for example, be a porous fine ceramic material, which may be sintered from Alumina, Titania or Zirconia. The membrane-based material may be composed of a hydrophobic polymer membrane, which may have pores 166 with pore sizes within a variety of ranges. For example, the pore sizes of the pores 166 may be within a range of: about 0.1 to 0.2 micrometers, 0.2 micrometers or less, 0.1 micrometers or less, 0.5 micrometers or less, 0.2 micrometers or less, 0.1 micrometers or less, or about 0.01 to 0.02 micrometers.

The membrane-based material may employ hydrophilic ceramic membranes with a high thermal conductivity to condense water vapors within the membrane pores. The membrane-based material may include a block copolymer or a sulfonated poly (ether ether ketone) (i.e., SPEEK).

As illustrated in FIG. 4, the water or moisture 168 selectively migrates from the fluid 138 passing through the second flow path 136, through the pores 166 of the membrane based material, and into the water acting as a first refrigerant 114 passing through the first flow path 134.

Referring to FIG. 5, an example is depicted of a schematic view of the water removal system 100 of FIG. 1, wherein the fluid 138 includes a flow of exhaust gas 216 from an internal combustion engine 202 of a primary power supply 200, according to aspects described herein. The primary power supply 200 includes the engine 202 having a crankshaft 205, which is connected to a primary generator 204.

The exhaust gas 216 flows from the engine 202 and may enter a turbine-generator system 206. The turbine generator system 206 may advantageously be utilized to supply electrical power to the water removal system 100. The turbine-generator system 206 is a form of bottoming cycle power system, that can be used to supply a portion of, or all, electrical power requirements of the water removal system 100. Such bottoming system power systems are described in issued U.S. Pat. No. 11,415,052, filed on Sep. 27, 2021, titled: SYSTEMS AND METHODS ASSOCIATED WITH BOTTOMING CYCLE POWER SYSTEMS FOR GENERATING POWER AND CAPTURING CARBON DIOXIDE, and in issued U.S. Pat. No. 11,346,256, filed on Sep. 27, 2021, titled: SYSTEMS AND METHODS ASSOCIATED WITH BOTTOMING CYCLE POWER SYSTEMS FOR GENERATING POWER, CAPTURING CARBON DIOXIDE AND PRODUCING PRODUCTS, both of which are incorporated herein by reference in their entirety.

The turbine-generator system 206 includes a turbo-expander 208 and turbo-compressor 212 disposed on a turbo-crankshaft 210. The turbo-expander 208 operates to rotate the turbo-crankshaft 210 as the flow of exhaust gas 216 from the engine 202 passes through the turbo-expander 208. The turbo-compressor 212 operates to compress the flow of exhaust gas 216 after the exhaust gas 216 passes through the turbo-expander 208. A bottoming cycle generator 214 may be disposed on the turbo-crankshaft 210. The bottoming cycle generator 214 may be connected to the water removal system 100. The bottoming cycle generator 214 may operate to provide at least a portion of electric power required to operate the water removal system 100.

During operation, the exhaust gas 216 from the internal combustion engine 202 enters and expands in the turbo-expander 208. By way of example, the exhaust gas 216 could enter the turbo-expander 208 at about 700 to 900 degrees Fahrenheit (F) and about 10 psi above atmospheric pressure. By doing so, the exhaust gas 216 does work by initiating rotation of the turbo-crankshaft 210 which rotates the turbo-compressor 212 and the bottoming cycle generator 214. Rotation of the turbo-compressor 212 results in a vacuum (for example, a vacuum in a range of about 4 to 10 psi below atmospheric pressure or about 10.7 to 4.7 pounds per square inch absolute (psia)) being pulled on the exhaust gas 216 as it passes through the turbo-expander 208. This vacuum pressure range advantageously increases the pressure differential across the turbo-expander 208 and, therefore, enhances the total power that can be generated by the bottoming cycle generator 214.

The exhaust gas 216 exits the turbo-expander 208 and then flows into the second flow path 136 of the transport membrane heat exchanger 132 of the evaporator section 110. More specifically in this example, the exhaust gas 216 enters the tube passageways 164 of the membrane tubes 156.

Advantageously, even though there is a substantial vacuum on the flow of exhaust gas 216 out of the turbo-expander 208 (which, in this example, is functioning as the hydrated fluid 138 in the second flow path 136 of the transport membrane heat exchanger 132), the absolute pressures of the exhaust gas 216 in the second flow path 136 are configured to be substantially greater than the absolute pressures of the water acting as a first refrigerant 114 evaporating in the first flow path 134 of the transport membrane heat exchanger 132 of the expander section 110. For example, the pressure on the exhaust gas 216 in the second flow path 136 may be configured to be about 10.6 to 4.6 psia greater than the pressure on the evaporating water/first refrigerant 114 in the composite ceramic tubes 156 of the first flow path 134. This positive pressure across the walls 162 of the ceramic tubes 156 greatly enhances the migration of moisture 168 from exhaust gas 216 to water/first refrigerant 114 in the evaporator section 110.

The exhaust gas 216 then exits the evaporator section 110 as cooled and dried exhaust gas 216. The exhaust gas 216 then flows into the turbo-compressor 212 of the turbine generator system 206, where it is compressed back to atmospheric pressures or greater. From the turbo-compressor 212, the cooled and dried exhaust gas 216 may flow into a carbon dioxide capture system 220, which removes the carbon dioxide from the exhaust gas 216. Advantageously, the carbon dioxide capture system functions more efficiently with the water 168 removed from the exhaust gas 216 and with the exhaust gas 216 cooled. From the carbon dioxide capture system 220, the exhaust gas 216 may flow up a stack 221 associated with the internal combustion engine 202.

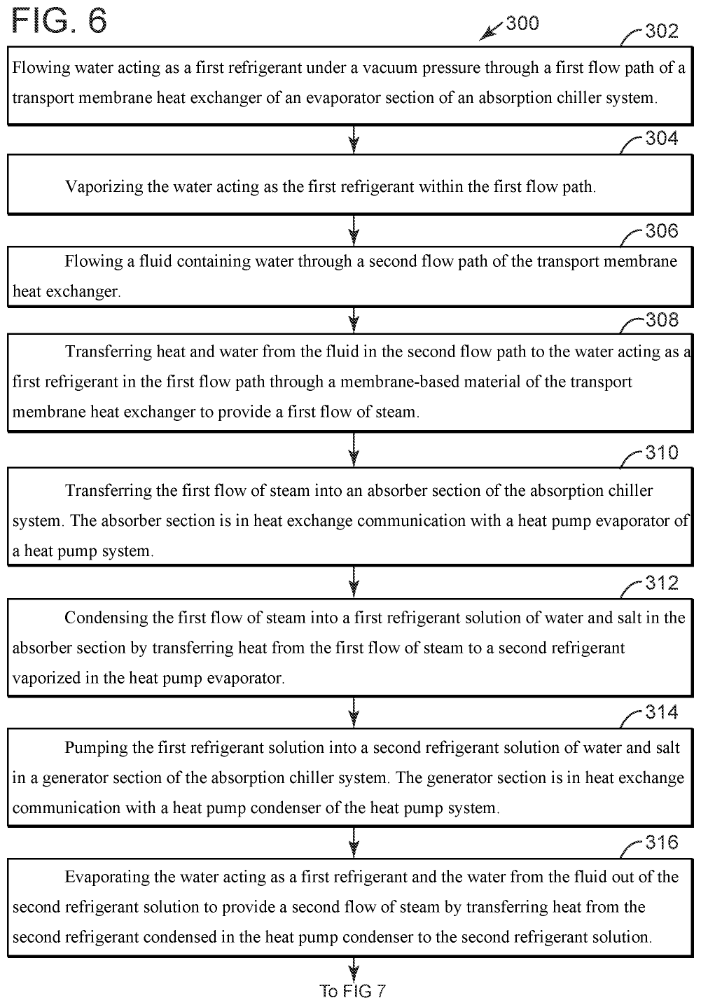

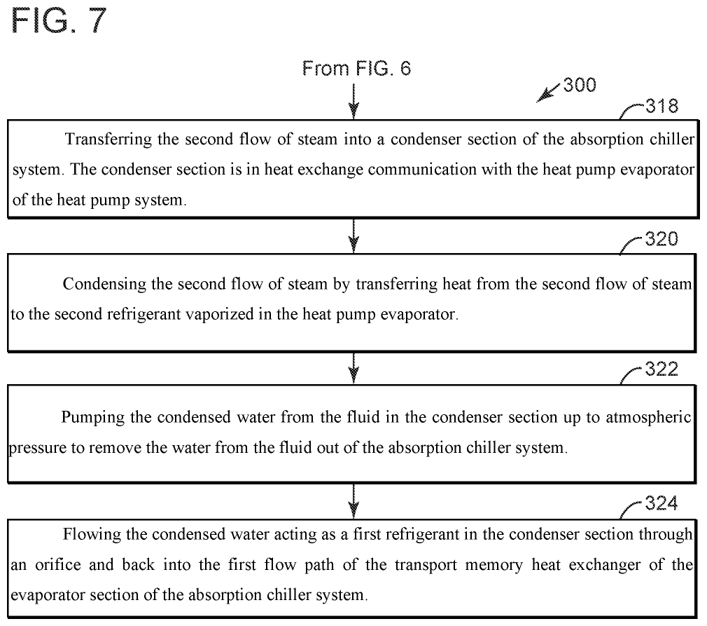

Referring to FIG. 6, an example is depicted of a flow diagram of a method 300 of removing water 168 from a fluid 118, according to aspects described herein.

The method 300 begins at 302, wherein water acting as a first refrigerant 114 under a vacuum pressure is flowed through a first flow path 134 of a transport membrane heat exchanger 132 of an evaporator section 110 of an absorption chiller system 102. The vacuum pressure may be in the range of about 1.0 psia or less, about 0.2 psia or less, or about 0.12 psia or less in the evaporator section 110.

At 304, the water acting as the first refrigerant 114 is vaporized within the first flow path 134. More specifically, the water/first refrigerant 114 may vaporize under vacuum conditions at temperatures as low as about 40 degrees F. (corresponding to a vacuum pressure of about 0.12 psia).

At 306, a fluid 138 containing water 168 is flowed through a second flow path 136 of the transport membrane heat exchanger/evaporator section 132/110. The heat from the fluid 138 in the second flow path 136 is the heat source which evaporates the water/first refrigerant 114 in the first flow path 134. The fluid 138 may be, for example, air or exhaust gas 216 from an internal combustion engine 202 (see FIG. 5).

At 308, heat and water 168 from the fluid 136 in the second flow path 136 is transferred to the water acting as a first refrigerant 114 in the first flow path 134 through a membrane-based material 162 (see FIG. 4) of the transport membrane heat exchanger 132 to provide a first flow of steam 140. The first flow of steam 140 includes the water acting as a first refrigerant 114 plus the water 168 from the fluid 138 passing through the second flow path 136.

At 310, the first flow of steam 140 is transferred into an absorber section 112 of the absorption chiller system 102. The absorber section 112 is in heat exchange communication with a heat pump evaporator 120 of a heat pump system 104. As illustrated in FIG. 1, the absorber section 112 is in heat exchange communication with the heat pump evaporator 120 via cooling coils 128 within the absorber section 112. More specifically, the cooling coils 128 circulate therethrough a second refrigerant 122 from the main body of the heat pump evaporator 120, which vaporizes within the cooling coils 128. The cooling coils 128 may be considered to be a part of the heat pump evaporator 120.

At 312, the first flow of steam 140 is condensed into a first refrigerant solution 142 of water and salt in the absorber section 112 by transferring heat from the first flow of steam 140 to the second refrigerant 122 vaporized in the heat pump evaporator 120. By evaporating the second refrigerant 122, the first flow of steam 140 (which contains the water acting as a first refrigerant 114 and the water 168 from the fluid 138) is efficiently cooled, and condensed, and mixes with the first refrigerant solution 142.

At 314, the first refrigerant solution 142 is pumped into a second refrigerant solution 146 of water and salt in a generator section 106 of the absorption chiller system 102. The second refrigerant solution 146 contains the same salt as the first refrigerant solution 142, but a different percentage of water 114, 168 to salt. The generator section 106 is in heat exchange communication with a heat pump condenser 118 of the heat pump system 104. As illustrated in FIG. 1, the generator section 106 is in heat exchange communication with the heat pump condenser 118 via heating coils 130 within the generator section 106. More specifically, the heating coils 130 circulate therethrough the second refrigerant 122 from the main body of the heat pump condenser 118, which condenses within the heating coils 130. The heating coils 130 may be considered to be a part of the heat pump condenser 118.

At 316, the water acting as a first refrigerant 114 and the water 168 from the fluid 138 is evaporated out of the second refrigerant solution 146 to provide a second flow of steam 150 by transferring heat from the second refrigerant 122 condensed in the heat pump condenser 118 to the second refrigerant solution 146.

Referring to FIG. 7, an example is depicted of a flow diagram of a continuation of the method 300 of removing water 168 from a fluid 138, according to aspects described herein.

The method 300 continues at 318, wherein the second flow of steam 150 is transferred into a condenser section 108 of the absorption chiller system 102. The condenser section 108 is in heat exchange communication with the heat pump evaporator 120 of the heat pump system 104. As illustrated in FIG. 1, the condenser section 108 is in heat exchange communication with the heat pump evaporator 120 via cooling coils 126 within the condenser section 108. More specifically, the cooling coils 126 circulate therethrough the second refrigerant 122 from the main body of the heat pump evaporator 120, which evaporates within the cooling coils 126. The cooling coils 126 may be considered to be a part of the heat pump evaporator 120.

At 320, the second flow of steam 150 is condensed by transferring heat from the second flow of steam 150 to the second refrigerant 122 vaporized in the heat pump evaporator 120.

At 322, the condensed water 168 from the fluid 138 is pumped (for example, via pump 153) in the condenser section 108 up to atmospheric pressure to remove the water 168 from the fluid 138 out of the absorption chiller system 102. In other words, the portion of the condensed steam 150 that represents the water 168 from the fluid 138, may be pumped via water pump 153 out of the condenser section 108 in order to maintain the volume of water/first refrigerant 114 circulating within the absorption chiller system 102 at a substantially constant level. The condensed water 168 removed from the absorption chiller system 102 may be used in the production of such products as distilled water or the like.

At 324, the condensed water acting as a first refrigerant 114 in the condenser section 108 is flowed through an orifice 154 and back into the first flow path 134 of the transport membrane heat exchanger 132 of the evaporator section 110 of the absorption chiller system 102. This completes the absorption chiller system's refrigerant cycle.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it have the full scope defined by the language of the following claims.

What is claimed is:

1. A water removal system comprising:
an absorption chiller system comprising a generator section, a condenser section, an evaporator section and an absorber section all in fluid communication with each other and which operate to circulate water as a first refrigerant therethrough; and
a heat pump system comprising a heat pump compressor, a heat pump condenser and a heat pump evaporator all in fluid communication with each other and which operate to circulate a second refrigerant therethrough;
wherein the heat pump evaporator is in heat exchange communication with at least one of the condenser section or the absorber section and is configured to evaporate the second refrigerant to transfer heat from the first refrigerant to the second refrigerant; and
wherein the heat pump condenser is in heat exchange communication with the generator section and is configured to condense the second refrigerant to transfer heat from the second refrigerant to first refrigerant.

2. The water removal system of claim 1, wherein the at least one of the condenser section or the absorber section comprises the condenser section and the absorber section.

3. The water removal system of claim 1, wherein the second refrigerant comprises one of water, carbon dioxide or refrigerant R471.

4. The water removal system of claim 1, wherein the heat pump evaporator is configured to evaporate the second refrigerant within a temperature range of 60 degrees Fahrenheit to 100 degrees Fahrenheit.

5. The water removal system of claim 1, wherein the heat pump condenser is configured to condense the second refrigerant within a temperature range of 180 degrees Fahrenheit to 200 degrees Fahrenheit.

6. The water removal system of claim 1, wherein:
the evaporator section comprises a transport membrane heat exchanger comprising a first and a second flow path,
the first flow path operable to flow the first refrigerant therethrough under a vacuum pressure that is low enough to vaporize the first refrigerant within the first flow path,
the second flow path operable to flow a fluid having water therethrough; and
wherein both water and heat are transferred from the fluid in the second flow path to the first refrigerant in the first flow path through a membrane-based material of the transport membrane heat exchanger, such that the fluid passing through the second flow path has at least a portion of its water removed and is cooled.

7. The water removal system of claim 1, comprising:
a water pump in fluid communication with the condenser section, the water pump configured to pump condensed water from the condenser section out of the water removal system.

8. The water removal system of claim 6, comprising:
the membrane-based material of the transport membrane heat exchanger comprising a plurality of membrane tubes, each tube of the plurality of tubes comprising an outside diameter, an inside diameter and a porous ceramic tube wall therebetween, the inside diameter of each tube defining a tube passageway therethrough;
the first flow path extending through the tube passageway of each tube;
the second flow path extending around the outside diameter of each tube; and
wherein, both water and heat from the fluid passing through the second flow path migrates through the tube walls of each tube to the first refrigerant in the first flow path.

9. The water removal system of claim 6, wherein the membrane-based material is a ceramic membrane-based material.

10. The water removal system of claim 6, wherein the fluid in the second flow path comprises a flow of air.

11. The water removal system of claim 6, wherein the fluid in the second flow path comprises a flow of exhaust gas from an internal combustion engine.

12. The water removal system of claim 11, comprising:
the second flow path operable to flow the exhaust gas therethrough under a vacuum pressure, the vacuum pressure in the second flow path being greater than the vacuum pressure in the first flow path.

13. The water removal system of claim 12, wherein the vacuum pressure in the second flow path is greater than the vacuum pressure in the first flow path by about 4.6 psi or greater.

14. The water removal system of claim 6, wherein the first flow path is operable to flow the first refrigerant therethrough under a vacuum pressure that is 0.2 psia or less.

15. The water removal system of claim 6, wherein the vacuum pressure in the first flow path is maintained by an attraction of the flow of first refrigerant to a salt in a solution of the first refrigerant in the absorber section.

16. The water removal system of claim 7, wherein:
the water transferred from the fluid in the second flow path mixes with the water functioning as a first refrigerant in the first flow path to form a total flow of water.

17. A method of removing water from a fluid, the method comprising:
flowing water acting as a first refrigerant under a vacuum pressure through a first flow path of a transport membrane heat exchanger of an evaporator section of an absorption chiller system;
vaporizing the water acting as the first refrigerant within the first flow path;
flowing a fluid containing water through a second flow path of the transport membrane heat exchanger;
transferring heat and water from the fluid in the second flow path to the water acting as a first refrigerant in the first flow path through a membrane-based material of the transport membrane heat exchanger, wherein the water from the fluid mixes with the water acting as a first refrigerant to provide a first flow of steam and wherein the fluid passing through the second flow path has at least a portion of its water removed and is cooled;
transferring the first flow of steam into an absorber section of the absorption chiller system, the absorber section in heat exchange communication with a heat pump evaporator of a heat pump system;
condensing the first flow of steam into a first refrigerant solution of water and salt by transferring heat from the first flow of steam to a second refrigerant vaporized in the heat pump evaporator;
pumping the first refrigerant solution into a second refrigerant solution of water and salt in a generator section of the absorption chiller system, the generator section in heat exchange communication with a heat pump condenser of the heat pump system; and
evaporating the water acting as a first refrigerant and the water from the fluid out of the second refrigerant solution to provide a second flow of steam by transferring heat from the second refrigerant condensed in the heat pump condenser to the second refrigerant solution.

18. The method of claim 17, comprising:
transferring the second flow of steam into a condenser section of the absorption chiller system, the condenser section in heat exchange communication with the heat pump evaporator of the heat pump system; and
condensing the second flow of steam by transferring heat from the second flow of steam to the second refrigerant vaporized in the heat pump evaporator.

19. The method of claim 18, comprising:
pumping the condensed water from the fluid in the condenser section up to atmospheric pressure to remove the water from the fluid out of the absorption chiller system.

20. The method of claim 19 comprising:
flowing the condensed water acting as a first refrigerant in the condenser section through an orifice and back into the first flow path of the transport memory heat exchanger of the evaporator section of the absorption chiller system.
